(19) United States
(12) Patent Application Publication
(10) Pub. No.: US 2003/0141233 A1
(43) Pub. Date: Jul. 31, 2003

(54) Chitosan coupling with removable lid

(76) Inventor: Douglas Paul Allard, Santa Rosa, CA (US)

Correspondence Address: Howrey Simon Arnold & White, 750 Bering Drive, Houston, TX, 77057, US

(21) Appl. No.: 10/057,557

(22) Filed: Jan. 25, 2002

(51) Int. Cl. C02F 1/68

(52) U.S. Cl. 210/198.1

(57) ABSTRACT

A chitosan enhanced coupling capable of assisting in the removal of silt, sedimentation and suspended solids from incoming water is disclosed. The inventive coupling generally comprises a first end defining an opening therethrough, a second end defining an opening therethrough, a midsection located between said first end and said second end, an auxiliary opening having a removable sealed lid and located along said midsection, and one or more applications of chitosan located within said midsection. A fabric sock containing one or more bars of chitosan gel is anchored to the removable lid for maximized exposure to incoming fluid. The midsection of the coupling has a diameter that is about twice the diameter of either the first or second ends, such that passing fluid slows as it passes through the midsection.

### FIELD OF THE INVENTION

The present invention relates generally to treating or clarifying polluted or dirty water and more particularly to devices and apparatuses for use in reducing the amount of silt, sedimentation and pollution in storm water runoff or other water being pumped or otherwise dispersed.

### BACKGROUND OF THE INVENTION

In response to tighter guidelines recently imposed by the federal Environmental Protection Agency under the Clean Water Act, controlling pollution, silt and sediment found in storm water runoff and other sources of water is receiving ever-increasing attention at all levels of government, federal, state and local. Federal and state agencies have issued mandates and developed guidelines regarding the prevention of non-point source (storm water caused) pollution that require local governments to act upon or initiate. These mandates affect water runoff from storms and also from other sources on slopes and construction sites. In addition, there are many other laws and regulations in place that restrict how any significant amount of water may be moved or disposed. Such laws and regulations have a significant impact on not only how storm water may be channeled and diverted, but also on, for example, the ways that contractors can dispose of excess or unwanted water from constructions sites. Regulations also exist as to how clean water must be as it is pumped away or “dewatered” from lakes, ponds and water filled trenches, such that undesirable excess silt and particles are not introduced into streams, storm sewers and surrounding property.

Dewatering bags, also known as “dirt bags,” are a common way of filtering or treating dirty water that must be pumped or otherwise moved from one location to another. Such dewatering bags are manufactured and sold commercially by numerous entities, with examples including ACF Environmental of Richmond, Vir., and Dandy Products, Inc. of Grove City, Ohio. Dewatering bags generally resemble a large bladder comprised of a permeable filtering membrane, such as a non-woven geotextile fabric, and are typically rectangular in nature, although other shapes may be available. Sizes vary widely according to anticipated fluid flow rates, and range anywhere from about four feet square to about fifteen feet square. An inlet spout extending from one side of the dewatering bag is typically able to accept an inlet hose, pipe or other type of coupling that is up to six inches in diameter. Water may be pumped into the dewatering bag from the desired source through this inlet hose or pipe at rates up to 1500 gallons per minute, depending upon factors such as the size of the bag and the permeability of the membrane.

Referring now to FIG. 1, a top perspective view of a prior art dewatering bag in operation is illustrated. In a typical application, a dewatering bag 10 is laid flat wherever pumped water is desired to be dispersed, and is ideally placed atop a bed of vegetation, straw, gravel or any other aggregate base 20 such that filtration and permeation through the bottom of the bag may be maximized. Dewatering bags may be used on either sloped or level surfaces as needed, and each type of surface has its own separate advantages. Once a source hose, pipe, coupling or other inlet fitting 30 is inserted into an inlet spout 11, a tie down strap or rope 12 firmly wraps around the inlet spout to secure it in place and prevent gross leakage of unfiltered water. Dirty water is then pumped into the dewatering bag, and the bag tends to balloon up in size as it fills. At the same time that water is being pumped into the bag, water 13 is constantly seeping out of or otherwise escaping the bag through the permeable material around all sides, top and bottom of the bag. Because the dewatering bag is made from a fabric or other type of permeable membrane 14, however, much of the sediment, silt and suspended solids in the incoming water are retained inside the bag. Of course, a very fine filtration level of the permeable membrane would result in a reduced aggregate flow capacity out of all sides of the bag, such that under most reasonable output flows, a good amount of sediment and fine solids do nevertheless pass through the membrane with the outgoing water.

Because many laws and regulations only require that pumped water be treated or clarified in some minimal way, however, a mere reduction in the murkiness of the water is sufficient for most dewatering bag applications. Although a dewatering bag is a popular means and good example for moving and filtering polluted, dirty or murky water, other such methods and systems for moving water exist as well. Other applications may involve tanks, channels, and storm drain systems, as well as simple hoses and piping systems. The foregoing examples are not inclusive, as other analogous applications for dewatering will be readily evident to those skilled in the art. As regulations tighten or various applications require a higher standard of filtration or clarification, however, most or all current methods and systems for dewatering at reasonably high flow rates may prove to be inadequate. Accordingly, more effective devices and systems for filtering or clarifying polluted or dirty water are desired.

Chitosan is a well-known material that is derived from a naturally occurring substance called chitin, which is a polysaccharide found in the exoskeleton of shellfish such as shrimp, lobster, and or crabs. While chitosan is has recently gained popularity as a dietary supplement, its inherent ability to generate small electrical charges has also provided benefits in the processing of contaminated items, such as wastewater. In turbid or polluted water, the electrical charges given off by chitosan react with the small electrical charges in pollution, fine silt and sediment particles, such that many of these tiny bits of contamination and silt coagulate together into larger chunks. These larger coagulated chunks of particles can then be filtered more easily from the fluid and are also more prone to settle to the bottom of the fluid body via gravity. An appropriate application of chitosan can render a body of muddy water as fairly clear in a short period of time. While chitosan and chitin have been previously used to some extent in the treatment of wastewater, their use has yet to reach the field of storm water runoff or other dirty water coming under other concerns of the Clean Water Act, with its accompanying objective to filter or clarify such water. Accordingly, more effective devices and systems are desired for filtering or clarifying polluted or dirty water using chitosan technologies.

### SUMMARY OF THE INVENTION

The present invention is directed toward an apparatus comprising one or more couplings or fittings that are particularly useful in clarifying dirty or muddy water. The inventive coupling or fitting is preferably coupled at a first end to a pipe, hose, other coupling or any other water delivery device as required by a particular application. A second water delivery device, such as another pipe, hose, or filtration apparatus is optionally attached to a second end of the inventive coupling. According to a preferred embodiment of the present invention, chitosan is placed inside the inventive coupling at one or more optimal locations such that its exposure to incoming or passing water is maximized. As a result, the inventive coupling is capable of contributing to the coagulation of fine solids into larger particles, such that passage of pollution, silt and sediment through the coupling itself and through any subsequent filtration device, such as a dewatering bag, is reduced.

In a particularly preferred embodiment, an auxiliary opening is formed at a side or top of the inventive coupling and is sealed off during operation by clamping a removable lid to the mouth of the opening. Use of a time release gel form of chitosan is preferred, and such a form is preferably provided in bars that are inserted and sewn into one or more compartments of a permeable fabric sock. This fabric sock containing multiple chitosan gel bars is then attached to a set location within the inventive coupling, preferably to an anchor attached to the underside of the removable lid sealing the auxiliary opening. In this manner, the chitosan sock may be easily removed and replaced within the coupling as needed. In a preferred embodiment, the midsection of the inventive coupling has a diameter that is greater than, and preferably about twice that, of either end, such that water passing through this midsection is slowed for greater exposure to the chitosan contained therein. For example, where the first and second ends have diameters of about three inches, midsection 103 would have a diameter of about six inches. In this manner, water needing treatment or clarification is given a maximum amount of exposure to the chitosan before passing through the coupling.

### BRIEF DESCRIPTION OF THE DRAWINGS

FIG. 1 is a top perspective view of a prior art dewatering bag in operation.

FIG. 2 is a side cross-sectional view of a preferred embodiment of the present invention.

FIG. 3 is a top cross-sectional view of the embodiment of the present invention illustrated in FIG. 2.

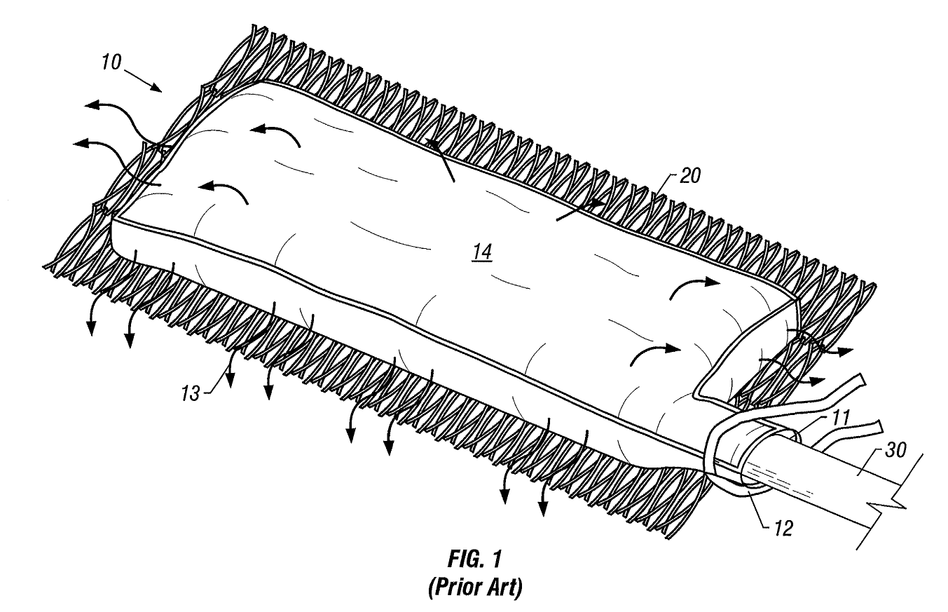

### DETAILED DESCRIPTION OF THE INVENTION

Recent water clarification technologies, such as those involving the use of chitosan, offer new opportunities to treat and clarify dirty or polluted water. The present invention provides improved devices and methods for treating and clarifying such water from numerous sources. One object of the present invention is to improve the ability of water treatment devices to remove unwanted pollution and solids from incoming water. Another object is to provide systems and devices that are more flexible in application. These and other useful objects are achieved by the improved devices and methods disclosed herein. In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

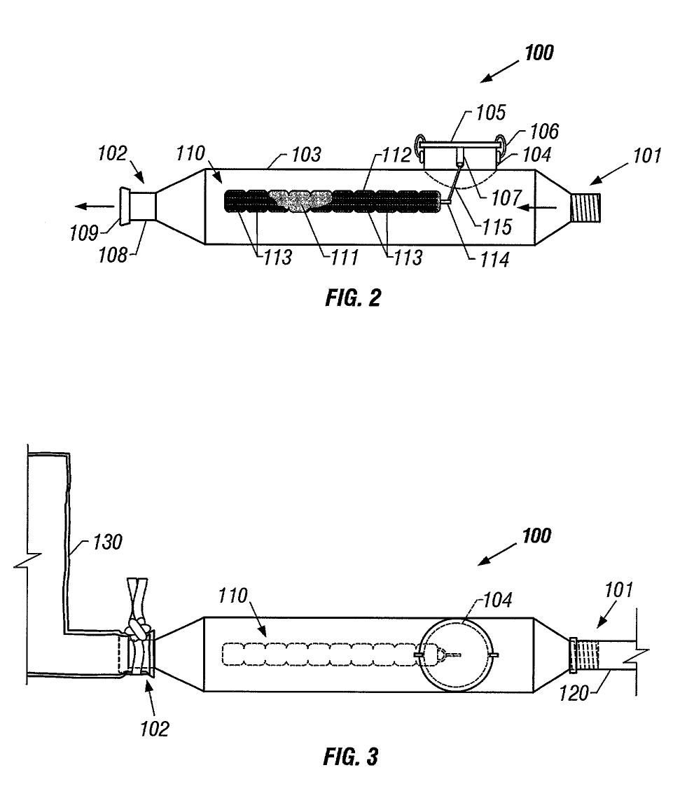

In particular, the present invention comprises one or more couplings or fittings that are particularly useful in clarifying dirty or muddy water, and that may be connected in tandem as any particular application requires. Referring to FIGS. 2 and 3, a preferred embodiment of the present invention is illustrated in side and top cross-sectional views respectively. Coupling 100 preferably comprises a first end 101, a second end 102, a midsection 103 and an auxiliary opening 104. As depicted in FIG. 3, coupling 100 is preferably coupled or otherwise attached at first end 101 to the outlet of a first water delivery device 120 that provides water from one or more sources. Such a device may comprise, for example, a pipe, hose, second coupling, or any other water delivery device as required by a particular application. A second coupling, if used, may or may not be substantially similar to coupling 100, as other adaptable coupling and additional water delivery devices will be readily understood by those skilled in the art. First end 101, which is preferably open and comprises a primary inlet for coupling 100, may be threaded according to any desired standard to facilitate attachment to any particular type of inlet source, such as a pipe. Although first end 101 may come in any shape or size as needed, it is contemplated that this first end be about three inches in diameter and have a cross-section that is circular and open at the center.

As depicted in FIG. 3, a second water delivery device 130, such as another pipe, hose, coupling or filtration apparatus is preferably attached at its inlet to second end 102 of coupling 100. In a particularly preferred embodiment, second water delivery device 130 comprises a filtration apparatus, such as a dewatering bag, for removing silt, sedimentation and other fine solids from passing water. Second end 102, which is preferably open and comprises a primary outlet for coupling 100, may also be threaded according to any desired standards to facilitate attachment to a desired type of outlet device, such as a pipe. Because the preferred outlet device is a dewatering bag, however, threading of second end 102 is typically not necessary. In the event that no threading is used on either second end 102 or first end 101, such an end preferably comprises neck 108 ending in lip 109 in order to better facilitate a connection with a water delivery device, such as a dewatering bag. Although second end 102 may come in any shape or size as needed, it is contemplated that this second end also be about three inches in diameter and have a cross-section that is circular and open at the center.

Referring again to both of FIGS. 2 and 3, one or more applications of chitosan 110 are placed inside coupling 100 at one or more optimal locations such that its exposure to incoming or passing water is maximized. As a result, coupling 100 is more capable of contributing to the coagulation of fine solids into larger particles, such that passage of pollution, silt and sediment through the coupling itself and through any subsequent filtration device, such as a dewatering bag, is reduced. In a particularly preferred embodiment, auxiliary opening 104 is formed at a side or top of coupling 100 and is sealed off during operation by removable lid 105. Such a sealing is made against the mouth of the auxiliary opening, and may be accomplished by any suitable means as would be known by one skilled in the art, including, for example, one or more gaskets, threaded attachments, pins, clamps, bolts and the like. In the example provided for purposes of illustration, auxiliary opening 104 is formed at the top of coupling 100, and is sealed shut by removable lid 105. Clamps 106 attached to the outside of the auxiliary opening hold the removable lid firmly in place and one or more gaskets (not shown) on the face of the lid and extending around its outer edge seals the lid to the mouth of the auxiliary opening.

Although any form of chitosan 110 may be applied, use of a time release gel form is preferred. In a particularly preferred application, bars 111 of a time release gel form of chitosan are inserted and sewn into a permeable fabric sock 112, and preferably each gel bar is sewn into a separate compartment 113 within the fabric sock. This fabric sock containing multiple chitosan gel bars comprises a loop 114 attached to a distal end of the sock, such that the entire sock may be anchored to a set location within coupling 100. Multiple fabric socks containing multiple applications of chitosan may be located in one or more locations within the coupling in this manner. In a particularly preferred embodiment, removable lid 105 comprises an anchor 107 attached to its underside, such that a fabric sock may be attached thereto. A D-ring, loop, or other connecting device 115 may connect anchor 107 with fabric sock loop 1 14, or alternatively, the fabric sock loop may connect directly to anchor 107. This fabric sock containing one or more chitosan gel bars is ideally anchored to the removable lid and within the coupling such that the entire sock becomes centrally and horizontally suspended within the inner space of the coupling while any substantial fluid flow passes therethrough. In this manner, water needing treatment or clarification is given a maximum amount of exposure to an application of chitosan before passing through the coupling. While coagulation of silt, sedimentation and fine solids may occur in the coupling with such larger particles being retained in the coupling itself, a greater benefit will typically be realized by a dewatering bag or other filtration device attached downstream of the coupling. Such an additional filtration device will be better able to filtrate and retain solids that have been made larger through the application of chitosan in the inventive coupling. In addition, because the chitosan sock is anchored to the removable lid, it may be easily removed and replaced within the coupling as needed whenever the effectiveness of the chitosan wears out.

In a particularly preferred embodiment, the dimensions of midsection 103 are optimized such that even greater exposure to said one or more applications of chitosan can be realized. Referring again to FIGS. 2 and 3, it can be seen that the internal diameter of coupling 100 expands from a smaller diameter at first end 101, which generally comprises the inlet of the coupling, to a larger diameter at midsection 103, which is preferably circular in cross-section and is where one or more chitosan applications 110 are preferably located. Because the cross-sectional area of the coupling is larger at this point, the flow of passing water is accordingly slowed through this region, such that exposure to the chitosan contained therein is increased. The diameter of coupling 100 then decreases from the end of midsection 103 until it reaches the smaller diameter at second end 102, which generally comprises the outlet of the coupling. Although a variety of dimensions may be used with favorable results, it is particularly contemplated that midsection 103 should have a diameter that is twice that of first end 101 and second end 102. For example, where the first and second ends have diameters of about three inches, midsection 103 would have a diameter of about six inches.

Although the foregoing invention has been described in some detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A coupling capable of passing fluid, comprising:
(a) a first end defining an opening therethrough;
(b) a second end defining an opening therethrough;
(c) a midsection located between said first end and said second end;
(d) an auxiliary opening located along said midsection; and
(e) one or more applications of chitosan located within said midsection.

2. The apparatus of claim 1, wherein said one or more applications of chitosan comprises a gel form.

3. The apparatus of claim 2, wherein said gel form of chitosan comprises one or more bars, said one or more bars being placed into a fabric sock, wherein said fabric sock is anchored to a set location within said midsection

4. The apparatus of claim 1, wherein said first end further defines an inlet.

5. The apparatus of claim 1, further comprising a removable lid closing off said auxiliary opening.

6. The apparatus of claim 5, wherein at least one of said one or more applications of chitosan is anchored to said removable lid.

7. The apparatus of claim 1, wherein the diameter of said midsection is substantially greater than the diameter of said first end.

8. The apparatus of claim 7, wherein the diameter of said midsection is about twice the diameter of said first end.

9. The apparatus of claim 1, wherein the diameter of said midsection is substantially greater than the diameter of said second end.

10. A water clarifying apparatus, comprising:
(a) a first water delivery device;
(b) a coupling having a first end, a second end, a midsection located between said first end and said second end and one or more applications of chitosan located within said midsection, said coupling attached to an outlet of said first water delivery device; and
(c) a second water delivery device, wherein said coupling is attached to an inlet of said second water delivery device.

11. The apparatus of claim 10, wherein said coupling further comprises an auxiliary opening.

12. The apparatus of claim 11, wherein said auxiliary opening comprises a removable lid.

13. The apparatus of claim 12, wherein at least one of said one or more applications of chitosan are anchored to said removable lid.

14. The apparatus of claim 10, wherein the diameter of said midsection is substantially greater than the diameter of said first end.

15. The apparatus of claim 11, wherein the diameter of said midsection is about twice the diameter of said first end.

16. The apparatus of claim 10, wherein the diameter of said midsection is substantially greater than the diameter of said second end.

17. The apparatus of claim 10, wherein said second water delivery device comprises a dewatering bag.

18. The apparatus of claim 17, wherein the diameter of said midsection is substantially greater than the diameter of said second end.

19. The apparatus of claim 17, wherein said coupling further comprises an auxiliary opening having a removable lid.

20. The apparatus of claim 19, wherein at least one of said one or more applications of chitosan are anchored to said removable lid.
